(19) United States
(12) Patent Application Publication
(10) Pub. No.: US 2012/0287415 A1
(43) Pub. Date: Nov. 15, 2012

(54) PICKUP DEVICE AND LITHOGRAPHY APPARATUS USING THE SAME

(75) Inventor: Ee-Yian TOH, Singapore (SG)

(73) Assignee: UNITED MICROELECTRONICS CORP., Hsinchu (TW)

(21) Appl. No.: 13/103,219

(22) Filed: May 9, 2011

(51) Int. Cl. G03B 27/58; B25J 9/00

(52) U.S. Cl. 355/72; 414/589

(57) ABSTRACT

A pickup device disposed on a base includes a driving unit, a pickup arm, a control unit, a passive arm and a control line. The control unit is disposed on the pickup arm and electrically connects to the pickup arm for controlling that. The passive arm is connected with the pickup arm. The control line is electrically connected between the driving unit and the control unit and embedded in the passive arm. Therefore, the passive arm can protect the control line from damage by suffering external force. Further, the times of being bent to broken of the control line can be reduced to elongate the life thereof. A lithography apparatus using the pickup device is also provided.

### FIELD OF THE INVENTION

The present invention relates to a process apparatus, and more particularly to a pickup device which is easily to be detected and a lithography apparatus using the same.

### DESCRIPTION OF THE RELATED ART

With the progress of technology, the size of electric product is tending to miniaturize. For increasing the yield of the electric product, the robot arm which can orientated precisely is used in various fabricating process of electric product, so that the element can be moved to the precisely location during the fabricating process. A lithography apparatus, for example, uses the robot arm for picking up the photo mask and removing it to a determined position accurately.

The robot arm is usually composed of a plurality of linking rods for increasing the degree of freedom of the robot arm, and the linking rods connect to each other through pivot or sliding element. However, the control lines of these robot arms are usually embedded in each linking rod, so the control lines would be bent and rubbed so as to be broken while the linking rods rotate 180 degrees. Additionally, when the robot arm has an exceptional operation, every linking rod should be taken apart to confirm the broken part of the control line. Accordingly, the line detection time would be increased as the number of the linking rods increased.

### BRIEF SUMMARY

The present invention is related to a pickup device which can reduce the line detection time.

The present invention is also related to a lithography apparatus which can reduce the line detection times and extend the lifetime thereof.

The present invention provides a pickup device disposed on a base includes a driving unit, a pickup arm, a control unit, a passive arm and a control line. The control unit is disposed on the pickup arm and electrically connects to the pickup arm for controlling that. The passive arm is connected with the pickup arm. The control line is electrically connected between the driving unit and the control unit and embedded in the passive arm.

The present invention provides a lithography apparatus including a mask, a base and a pickup device disposed on a base. The pickup device includes a driving unit, a pickup arm, a control unit, a passive arm and a control line. The control unit is disposed on the pickup arm and electrically connects to the pickup arm for controlling that. The pickup arm is used for picking up the mask to perform an exposing process. The passive arm is connected with the pickup arm. The control line is electrically connected between the driving unit and the control unit and embedded in the passive arm.

In on embodiment of the invention, the pickup arm includes a plurality of driving arms, a carrying arm and a plurality of joints disposed between the driving arms connected with each other and between the carrying arm and the driving arm connected thereto.

In on embodiment of the invention, the joints may be pivots and sliding elements.

In on embodiment of the invention, the passive arm includes a first linking rod and a second linking rod. The first linking rod is connected between the pickup arm and the second linking rod, and the second linking rod is connected between the first linking rod and the base.

In on embodiment of the invention, the passive arm has a sliding portion and the base has a guiding trough. The sliding portion is disposed and movable in the guiding trough.

In on embodiment of the invention, the passive arm has a guiding trough and the base has a sliding portion. The sliding portion is disposed and movable in the guiding trough.

The control line of the pickup device is embedded in the passive arm, so that the control line can be protected by the passive arm from external force. Also, the bending times of the control line can be reduced and the life of the control line can be elongated. Further, the detecting process can be simplified and the time-consuming of lines detection can be reduced.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a schematic view of the lithography apparatus according to an embodiment of the present invention;

FIG. 2 is a schematic view of the pickup device according to another embodiment of the present invention; and

FIG. 3 is a schematic view of the pickup device according to another embodiment of the present invention.

### DETAILED DESCRIPTION

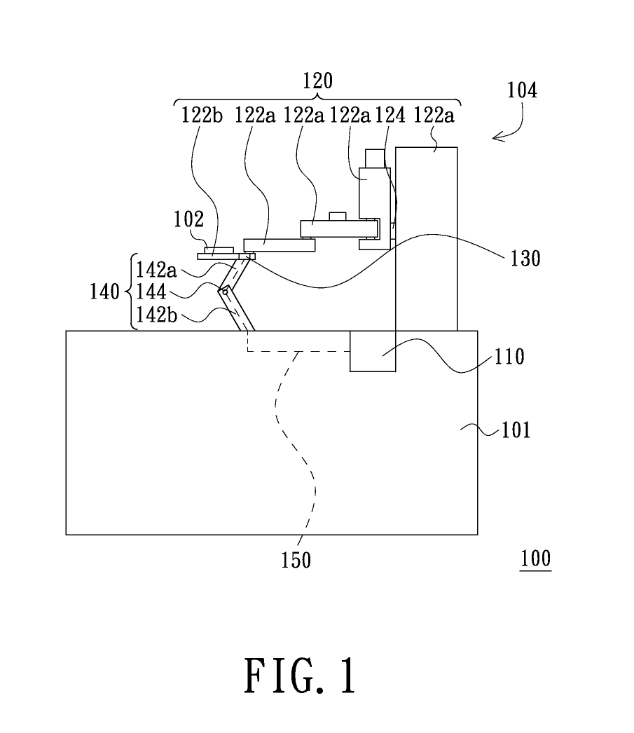

FIG. 1 is a schematic view of the lithography apparatus according to an embodiment of the present invention. Referring to FIG. 1, the lithography apparatus 100 includes a base 101, a mask 102 and a pickup device 104 disposed on the base 101. The pickup device 104 includes a driving unit 110, a pickup arm 120, a control unit 130, a passive arm 140 and a control line 150. The control unit 130 is disposed on the pickup arm 120 and electrically connected thereto. That is, the control unit 130 is used for controlling the actions of the pickup arm 120.

In this embodiment, the pickup arm 120 is composed of a plurality of driving arms 122a, a carrying arm 122b and a plurality of joints 124 used for connecting the driving arms 122a and the carrying arm 122b. In specific, the pickup arm 120 has four driving arms 122a and one carrying arm 122b used for carrying the mask 102. The joints 124 can be pivots and sliding elements connected between two driving arms 122a, so that the driving arms 122a can rotate or move respective to each other. Further, one of the joints 124 is connected between the carrying arm 122b and the driving arm 122a. Therefore, the carrying arm 122b can rotate relative to the driving arm 122a. Specifically, the carrying arm 122b can, for example, rotate at least 180 degrees relative to the driving arm 122a connected thereto for picking up the mask 102 and removing the mask 102 to an accurate position for performing exposing process.

The passive arm 140 is connected with the pickup arm 120. In this embodiment, the control unit 130 is, for example, disposed on the carrying arm 122b of the pickup arm 120, and the passive arm 140 is connected to the carrying arm 122b, but the invention is not limited hereto.

In detail, the passive arm 140 is, for example, composed of a first linking rod 142a, a second linking rod 142b and a plurality of joints 144. In this embodiment, the second linking rod 142b is pivoted between the base 101 and the first linking rod 142b through the joint 144. Therefore, the pickup arm 120 can drive the passive arm 140 to have a reciprocating motion in a predetermined area.

It should be noted that the passive arm 140 is not limited to whether immediately connect to the base 101. In the other embodiment, the passive arm 140 can connect to some element fixed on the base 101.

The control line 150 is connected between the driving unit 110 and the control unit 130 and embedded in the passive arm 140. Specifically, the signals output from the driving unit 110 are transmitted to the control unit 130 via control line 150, and then the motions of the driving arms 122a and the carrying arm 122b of the pickup arm 120 are controlled by the control unit 130 according to the received signals. In this embodiment, the driving unit 110 is, for example, embedded in the base 101.

Since the control line 150 is embedded in the passive arm 140 and the rotate angle of the passive arm 140 is small, it can prevent control line 150 from overbending and broken. Moreover, if the operation of the pickup device 104 is exceptional, only the passive arm 140 should be taken apart for replacing the control line 150. Therefore, the detection and fix time of the pickup device 104 may be reduced.

Additionally, the motion of the passive arm 140 may be straight for reducing the times of being bent of the control line 150. It would be described in the following embodiment.

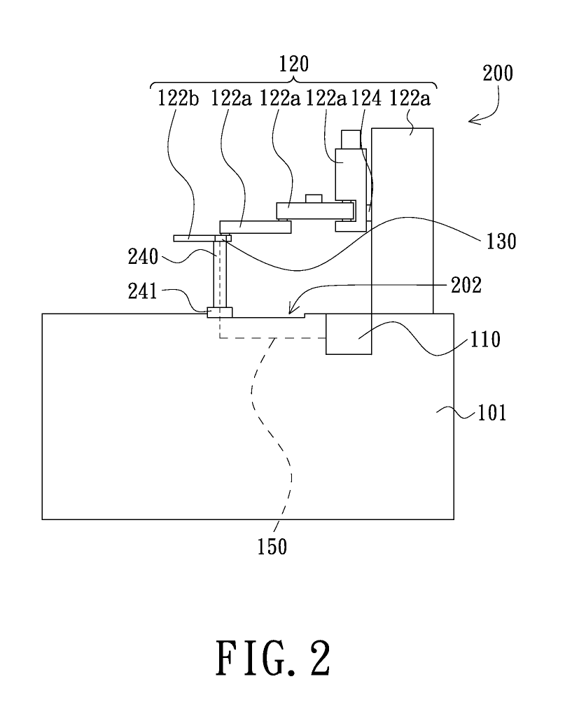

FIG. 2 is a schematic view of the pickup device according to another embodiment of the present invention. Referring to FIG. 2, the difference between the pickup device 200 and the pickup device 104 shown in FIG. 1 is about the liking rod of the passive arm 240. The other elements have the same index numbers with FIG. 1 are described in the aforementioned paragraphs.

In this embodiment, the passive arm 240 has a sliding portion 241 and the base 101 has a guiding trough 202. Further, the sliding portion 241 is disposed in the guiding trough 202. Accordingly, the passive arm 240 would be driven by the pickup arm 120 and then the sliding portion 241 would slide in the guiding trough 202.

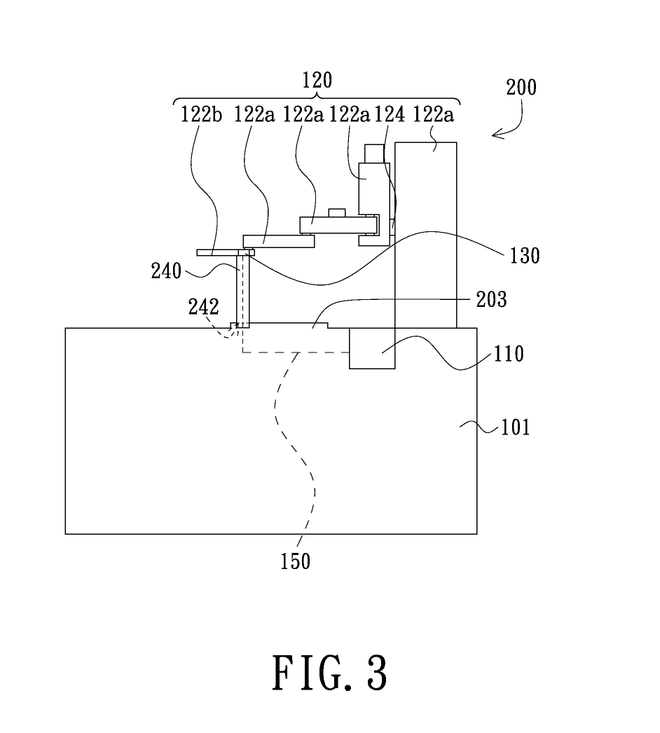

In another embodiment, the passive arm 240 may has a guiding trough 242 and the base 101 has a sliding portion 203, as shown in FIG. 3. With the same reason, the passive arm 240 would be driven by the pickup arm 120 and then the sliding portion 203 of the base 101 can has a relative motion with respect to the guiding trough 242.

As the mentioned, the passive arm of the present invention is not limited to whether immediately connect to the base 101, the one skilled in this art may select the connecting way between the passive arm 240 and the base 101 according to the practicality.

According to FIG. 2 and FIG. 3, when the passive arm 240 is driven by the pickup arm 120, the passive arm 240 can move straightly and without any rotation relative to the base 101, therefore it can prevent the control line 150 embedded within the passive arm 240 from being bent to broken, and the life of the control line 150 can be elongated.

In summary, the pickup device of the present invention not only includes the pickup arm for picking up object, also includes the passive arm. Moreover, since the control line is embedded in the passive arm, the control line can be protected from the external force and the times of being bent of the control line can be reduced to elongate the life of the control line. Furthermore, the line detection process may be simplified and time-consuming can be reduced.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A pickup device disposed on a base comprising:
a driving unit;
a pickup arm;
a control unit disposed on the pickup arm and electrically connecting thereto;
a passive arm connecting with the pickup arm; and
a control line electrically connecting between the driving unit and the control unit and embedded in the passive arm.

2. The pickup device as claimed in claim 1, wherein the pickup arm comprises:
a plurality of driving arms;
a carrying arm connected with one of the driving arms; and
a plurality of joints disposed between the driving arms connected with each other and between the carrying arm and the driving arm connected thereto.

3. The pickup device as claimed in claim 1, wherein the joints comprise pivots and sliding elements.

4. The pickup device as claimed in claim 1, wherein the passive arm comprises a first linking rod and a second linking rod, the first linking rod connecting between the pickup arm and the second linking rod, and the second linking rod connecting between the first linking rod and the base.

5. The pickup device as claimed in claim 4, wherein the second linking rod is pivoted between the base and the first linking rod.

6. The pickup device as claimed in claim 1, wherein the passive arm has a sliding portion, the base has a guiding trough the sliding portion disposed and being movable therein.

7. The pickup device as claimed in claim 1, wherein the passive arm has a guiding trough, the base has a sliding portion disposed in the guiding trough and being movable therein.

8. A lithography apparatus, comprising:
a mask;
a base;
a lithography apparatus disposed on the base, comprising:
a driving unit;
a pickup arm used for picking up the mask to perform exposing process;
a control unit disposed on the pickup arm and electrically connecting thereto;
a passive arm connecting with the pickup arm; and
a control line electrically connecting between the driving unit and the control unit and embedded in the passive arm.

9. The lithography apparatus as claimed in claim 8, wherein the pickup arm comprises:
a plurality of driving arms;
a carrying arm connected with one of the driving arms and used for carrying the mask; and
a plurality of joints disposed between the driving arms connected with each other and between the carrying arm and the driving arm connected thereto.

10. The lithography apparatus as claimed in claim 8, wherein the joints comprise pivots and sliding elements.

11. The lithography apparatus as claimed in claim 8, wherein the passive arm comprises a first linking rod and a second linking rod, the first linking rod connecting between the pickup arm and the second linking rod, and the second linking rod connecting between the first linking rod and the base.

12. The lithography apparatus as claimed in claim 11, wherein the second linking rod is pivoted between the base and the first linking rod.

13. The lithography apparatus as claimed in claim 8, wherein the passive arm has a sliding portion, the base has a guiding trough the sliding portion disposed and being movable therein.

14. The lithography apparatus as claimed in claim 8, wherein the passive arm has a guiding trough, the base has a sliding portion disposed in the guiding trough and being movable therein.
